(19) United States
(12) Patent Application Publication
(10) Pub. No.: US 2005/0163013 A1
(43) Pub. Date: Jul. 28, 2005

(54) CD cleaning apparatus

(76) Inventor: Mark Hargett, Escondido, CA (US)

Correspondence Address: Mark Hargett, 1250 Plesant Hills, Escondido, CA, 92026, US

(21) Appl. No.: 10/763,350

(22) Filed: Jan. 23, 2004

(51) Int. Cl. G11B 3/58; G11B 17/03; G11B 17/04; G11B 33/02; G11B 7/24; G11B 23/03

(52) U.S. Cl. 369/72; 720/600

(57) ABSTRACT

A simple device for cleaning CD's that has an outer case that can be made from many materials such as wood, metal, plastic or rubber. Inside the outer case are upper and lower cleaning pads made from a number of soft materials suitable for cleaning a CD with or without a cleaning solution. The width of the CD cleaner is slightly less than ½ the diameter of the CD which allows the person cleaning the CD to avoid touching the data surface of the CD. Another aspect of the invention is the space between the two cleaning pads which allows good cleaning action without excessive friction.

### FIELD OF THE INVENTION

The present invention relates to an apparatus for cleaning CD's in which the CD passed through a cleaning channel having a width that allows the person cleaning the CD to avoid touching the data surface.

### BACKGROUND OF THE INVENTION

Millions of people have compact disk players in their homes or in their automobiles that use compact disks, commonly known as CD's, as a source of audio and video entertainment. Personal computers or PC's are almost always equipped with a CD player that can be used to present sound, video and text. When the CD becomes dirty, the data transferred from the CD can become distorted causing a degradation sound and visual information. Another problem with using dirty CD's is the dust and dirt particles get transferred into the CD player thus causing problems and shortening the life span of the player. Some CD cleaning systems currently on the market are relatively bulky and require more time than should be necessary to clean the CD.

It would be an advantage to have a compact cleaning apparatus for cleaning CD's that is inexpensive, compact, easily stored, durable and quick to use. Such a system should also have superior cleaning ability with cleaning pads that are reusable. Some U.S. Patents such as U.S. Pat. Nos. 487,446, 2,187,491, 2,977,127, 4,257,616, 4,486,916, 4,569,098, 4,641,391, 4,709,437, 4,841,592, 5,584,089, 5,964,650, 6,189,446 and 6,243,345 show systems for cleaning knives, razors, phonograph records and CD's. These systems have limitations due to complexity or have limitations related to handling the record that is being cleaned. To overcome the limitations of those systems the present invention has been developed.

### SUMMARY OF THE INVENTION

The present invention is a simple device for cleaning CD's that is easy to use, easily stored, compact, inexpensive to manufacture and highly effective. The CD cleaner has an outer case that can be made from many materials such as wood, metal, plastic or rubber. Inside the outer case are an upper and lower cleaning pads that can be made from a number of soft materials suitable for cleaning a CD with a cleaning solution. The width of the CD cleaner is slightly less than ½ the diameter of the CD which allows the person cleaning the CD to avoid touching the data surface of the CD. A wider width will result in the necessity to touch the data surface to finish the cleaning process. Another aspect of the present invention is the space between the two cleaning pads. This space is critical because it dictates the amount of friction between the CD and the cleaning pads. This amount of friction is important because too little friction results in poor cleaning contact and too much friction causes too tight a fit for the CD.

The present device allows a person to quickly and easily clean a CD without touching the data surface. The device is compact, easy to store and has superior cleaning ability.

The object of the present invention is to provide an inexpensive CD cleaner that is simple to use and compact for easy storage.

It is another object of the invention to provide a CD cleaner that can be used without the necessity of touching the data surface to complete the cleaning process.

It is a further object of the invention to provide a CD cleaner with superior cleaning ability and that can be manufactured from a variety of materials that will enhance aesthetics as well as durability.

The novel features of the present invention are set forth with particularity in the appended claims. The invention will best be understood from the following description when read in conjunction with the accompanying drawings in which:

### BRIEF DESCRIPTION OF THE DRAWINGS

FIG. 1 is a top view of the present invention;

FIG. 2 is a front view of the present invention showing the cleaning pads;

FIG. 3 is side view of the CD cleaner;

FIG. 4 is a cross sectional side view showing the location of the cleaning pads;

FIG. 5 is a prospective view of the present invention showing the cleaning pads; and

FIG. 6 is a top view showing a CD in the process of being cleaned by the present invention.

### DETAILED DESCRIPTION OF THE PREFERRED EMBODIMENT

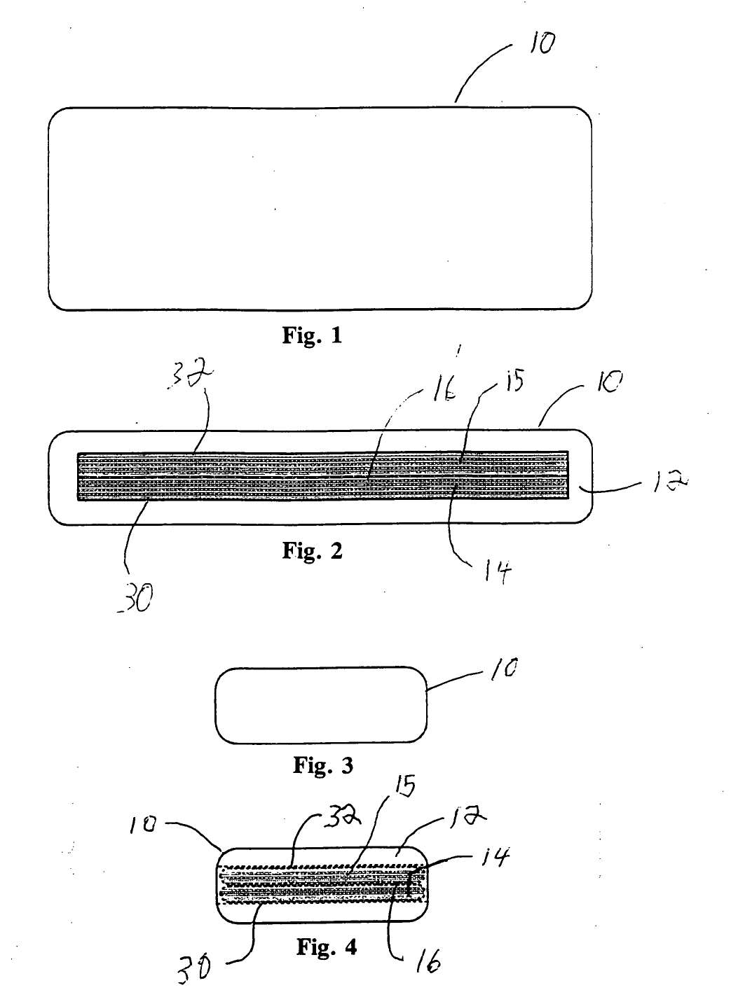

The present invention is a simple device for cleaning CD's that is easy to use, easily stored, compact, inexpensive to manufacture and highly effective. The dimensions of the device allow a CD to be cleaned without touching the data surface. The device can be manufactured from many materials including wood, plastic and metal or combinations of the materials. The device will now be explained in greater detail with reference to FIGS. 1 through 6.

FIG. 1 shows a top view of the CD cleaner 10 in its approximate actual size. This figure illustrates the compact nature of the present invention. FIG. 2 shows a front view of the CD cleaner 10. The CD cleaner 10 has a case 12 and lower and upper cleaning pads 14 and 15 respectively. Between lower and upper cleaning pads 14 and 15 is a cleaning space 16. A CD is inserted in the cleaning area 16 and is pushed through to the other side of the CD cleaner 10 to clean the CD. The cleaning pads 14 and 15 are attached to the case 12 at junctions 30 and 32. The cleaning pads 14 and 15 can be permanently attached to the case 12 by a variety of bonding methods such as gluing or epoxy. The cleaning pads 14 and 15 can also be removable for replacement or cleaning of the pads. Removable pads can be held in place by a variety of standard means including but not limited to a snap fit, press fit or slidable latch (all not shown).

When the cleaning pads 14 and 15 are installed in the case 12, the cleaning pads are lightly pressed against each other at cleaning area 16. This provides enough friction, when the CD is passed through the CD cleaner 10, to effectively clean the CD without making it too difficult to pass the CD through the CD cleaner.

The case 12 can be a one or two piece design and can be made from many different materials such as woods, metals and plastics. This provides a wide range of manufacturing options to control the cost of manufacturing as well as the aesthetics of the finished product. FIGS. 3 and 4 are respectively a side view and a cross sectional side view of the present invention. FIGS. 3 and 4 show the width of the CD cleaner 10 to be approximately 2 inches. The width of the CD cleaner 10 is critical to the invention because it allows the CD to be cleaned without touching the data surface. This aspect of the invention will be shown in greater detail with reference to FIG. 6. A standard CD has a diameter that is a little over 4.5 inches wide. If the CD cleaner is wider that approximately 2.75 inches, then it will be necessary to touch the data surface of the CD to pull it through the CD cleaner once the CD has been pushed through the CD cleaner as far as it can be on one side.

Also shown in FIG. 4 is the case 12, the lower and upper cleaning pads 14 and 15, cleaning area 16 and the attachment junctions 30 and 32. This figure illustrates the position of the of the lower and upper cleaning pads 14 and 15 inside the case 12. The cleaning pads have an outer covering that has a soft surface that contacts the CD. The inside of the cleaning pad can be a pliable material such as foam that will exert a force onto the CD when the CD compresses the foam as the CD is pushed through the CD cleaner. Different density foam or other pliable materials may be used in conjunction with the spacing between the pads to provide a reliable cleaning surface.

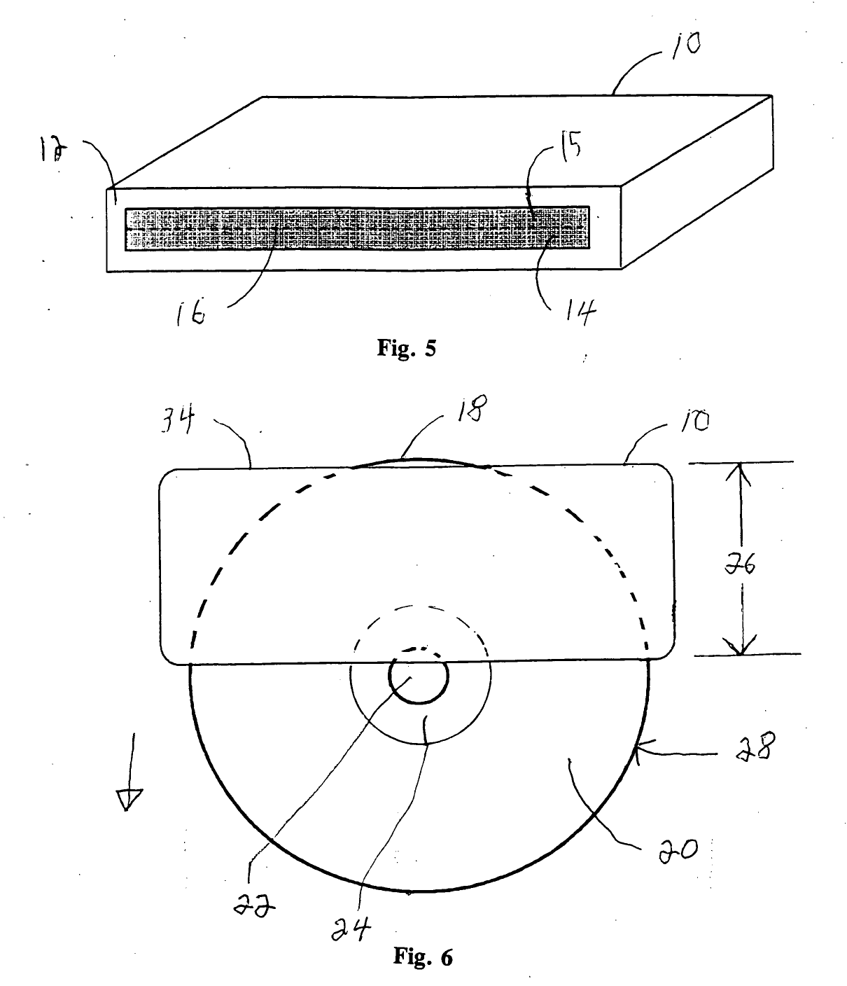

FIG. 5 is a perspective view of the CD cleaner 10, the case 12, lower and upper cleaning pads 14 and 15 and cleaning area 16. FIG. 6 is a top view of a CD 28 passing through the CD cleaner 10. The CD 28 is inserted into the cleaning area 16 (not shown in this figure) at side 34 of the CD cleaner. The CD 28 is pushed through the CD cleaner 10 at point 18 of the CD. When point 18 of the CD reaches side 34 of the CD cleaner 10, it is no longer possible to push the CD through the CD cleaner. A person will then grasp the CD 28 in the clear area 24 and the hole 22 to pull the CD 28 the rest of the way through the CD cleaner 10. The clear area 24 and the hole 22 do not contain any digital information so that putting finger prints in this area will not affect the performance of the CD. If the width 26 of the CD cleaner 10 is any larger than approximately 2.75 inches then it will be necessary to touch the data surface 20 to pull the CD 28 through the CD cleaner. This would leave finger prints on the data surface 20 that could adversely affect the performance of the CD.

This invention thus provides a CD cleaner that is compact, easy to use, easy to store, highly effective and inexpensive to manufacture. While the CD cleaning device of the present invention is shown with reference to FIGS. 1 through 6, the instant invention is not limited to the exact devices shown herein, for obvious modifications can be made by a person skilled in the art.

1. A device for cleaning a CD comprising:
case means having an inner area for holding cleaning pads, said case means having a length of at least 4.5 inches and a width no more than 2.75 inches upper and lower cleaning pads removeably held in said inner area in a manner creating a cleaning area between the upper and lower cleaning pads.

2. A device for cleaning a CD comprising:
case means having an inner area for holding cleaning pads, said case means having a length of at least 4.5 inches and a width of up to 2.75 inches
upper and lower cleaning pads held in said inner area in a manner creating a cleaning area between the upper and lower cleaning pads.

3. The device of claim 2 wherein:
said upper and lower cleaning pads have an outer cleaning surface covering an inner pliable material.

4. The device of claim 3 wherein:
said inner pliable material is foam.

5. A device for cleaning a CD comprising:
rectangular case means having an inner area for holding cleaning pads, said case means having a length of at least 4.5 inches and a width of up to 2.75 inches
upper and lower cleaning pads held in said inner area in a manner creating a cleaning area between the upper and lower cleaning pads
said upper and lower cleaning pads have an outer cleaning surface covering an inner pliable material.
